(19) United States
(12) Patent Application Publication
(10) Pub. No.: US 2022/0137190 A1
(43) Pub. Date: May 5, 2022

(54) LiDAR ADAPTIVE SCANNING SYSTEM AND METHOD USING IMAGE INFORMATION CONVERGENCE

(71) Applicant: INFOWORKS INC., Seoul (KR)

(72) Inventor: Hyun-Ju Park, Seoul (KR)

(21) Appl. No.: 17/410,946

(22) Filed: Aug. 24, 2021

(30) Foreign Application Priority Data
Nov. 2, 2020 (KR) 10-2020-0144441

(51) Int. Cl. G01S 7/481; G01S 17/10

(52) U.S. Cl. CPC G01S 7/4817; G01S 7/483; G01S 17/10

(57) ABSTRACT

The present invention relates to a light detection and ranging (LiDAR) adaptive scanning system and method using image information convergence, and more particularly, to a LiDAR adaptive scanning system and method using image information convergence, which are capable of deriving light ranging through LiDAR without restrictions on space and obstacles through adaptive scanning by converging multiple pieces of information according to images.

### CROSS-REFERENCE TO RELATED APPLICATION

This application claims the benefit of Korean Patent Application No. 10-2020-0144441, filed on Nov. 2, 2020, in the Korean Intellectual Property Office, the disclosure of which is incorporated herein in its entirety by reference.

### BACKGROUND

### 1. Field

The present invention relates to a light detection and ranging (LiDAR) adaptive scanning system and method using image information convergence, and more particularly, to a LiDAR adaptive scanning system and method using image information convergence, which are capable of deriving light ranging through LiDAR without restrictions on space and obstacles through adaptive scanning by converging multiple pieces of information according to images.

### 2. Description of Related Art

Light distance detection for mnemonic light detection and ranging (LiDAR) is used in various applications including altitude measurement, imaging, and collision avoidance. LiDAR provides a denser scale range resolution with a smaller beam size than a conventional microwave ranging system such as radio-wave detection and ranging (RADAR). Light distance detection may be achieved by various technologies including direct ranging based on the round trip time of an optical pulse with respect to an object, chirped detection based on the frequency difference between a transmitted chirped optical signal and a return signal scattered from an object, and phase encoding detection based on a sequence of single frequency phase shift distinguishable from natural signals.

In addition, in order to achieve acceptable distance accuracy and detection sensitivity, a direct long-range LiDAR system uses a short pulse laser having a low pulse repetition rate and very high pulse peak power. The high pulse power may lead to rapid performance degradation of optical components. A chirp and phase-encoding LiDAR system uses a long optical pulse having relatively low peak optical power. In this configuration, since the distance accuracy increases with the chirp bandwidth or length of the phase code, not the pulse duration, excellent distance accuracy may still be obtained.

However, the related art achieves a useful optical chirp bandwidth by using a wideband radio frequency (RF) electrical signal to modulate an optical carrier. Recently developed chirp LiDARs use the same modulated optical carrier as a reference signal to be combined with a return signal fed back to a photodetector to generate an electrical signal having a relatively low beat frequency proportional to a frequency or a phase between reference signals and return optical signals and measure a distance through the corresponding signal.

Therefore, there is a need to develop a technology in which a denser scale range resolution can be provided with a small beam size and light distance detection can perform LiDAR adaptive scanning through image information convergence, which is capable of deriving light ranging through LiDAR without restrictions on space and obstacles through adaptive scanning by converging multiple pieces of information according to images on the basis of direct ranging based on the round trip time of an optical pulse with respect to an object, chirped detection based on the frequency difference between a transmitted chirped optical signal and a return signal scattered from an object, and a sequence of single frequency phase shift distinguishable from natural signals.

### CITATION LIST

### Patent Literature

(Patent Literature 1) Korean Patent Publication No. 10-2019-0087615

### SUMMARY

The present invention has been made in an effort to solve the problems of the related art, and provides a LiDAR adaptive scanning system and method using image information convergence, in which a denser scale range resolution can be provided with a small beam size and light distance detection is capable of deriving light ranging through LiDAR without restrictions on space and obstacles through adaptive scanning by converging multiple pieces of information according to images on the basis of direct ranging based on the round trip time of an optical pulse with respect to an object, chirped detection based on the frequency difference between a transmitted chirped optical signal and a return signal scattered from an object, and a sequence of single frequency phase shift distinguishable from natural signals.

In order to achieve the above objects, the present invention includes: generating a laser control signal based on a LiDAR set value; measuring a target spatial resolution for ranging with respect to an object existing at a target maximum distance in a LiDAR scanning laser ranging view through the generated laser control signal; determining a coarse angular resolution to generate a coarse spatial resolution greater than the target spatial resolution at the target maximum distance; obtaining a plurality of coarse ranging values through a first dimensional coarse angular resolution and a second dimensional coarse angular resolution based on the determined coarse angular resolution; determining a first dimensional angular bin size based on the first dimensional coarse angular resolution and the second dimensional coarse angular resolution based on the determined coarse angular resolution; determining a second dimensional minimum angle and a second dimensional maximum angle through the determined first dimensional angle bin size; and performing final ranging through adaptive scanning properties including a set of the obtained coarse ranging values, the second dimension minimum angle, and the second dimension maximum angle.

In addition, the present invention includes: a laser generation unit configured to generate a laser control signal based on a LiDAR set value; a spatial resolution measurement unit configured to measure a target spatial resolution for ranging with respect to an object existing at a target maximum distance in a LiDAR scanning laser ranging view through the generated laser control signal; a coarse angular resolution determination unit configured to determine a coarse angular resolution to generate a coarse spatial resolution greater than the target spatial resolution at the target maximum distance; a coarse ranging unit configured to obtain a plurality of coarse ranging values through a first dimensional coarse angular resolution and a second dimensional coarse angular resolution based on the determined coarse angular resolution; a bin size determination unit configured to determine a first dimensional angular bin size based on the first dimensional coarse angular resolution and the second dimensional coarse angular resolution based on the determined coarse angular resolution; a second dimensional angular determination unit configured to determine a second dimensional minimum angle and a second dimensional maximum angle through the determined first dimensional angle bin size; and an adaptive scanning unit configured to perform final ranging through adaptive scanning properties including a set of the obtained coarse ranging values, the second dimension minimum angle, and the second dimension maximum angle.

### DETAILED DESCRIPTION

The terms or words used in the present specification and the claims should not be construed as being limited to ordinary or dictionary meanings. The inventors should be construed as meanings and concepts consistent with the technical idea of the present invention, based on the principle that the concept of the terms can be appropriately defined in order to explain their invention in the best way.

The configuration shown in the embodiments and drawings described in this specification is only the most preferred embodiment of the present invention, and does not represent all the technical idea of the present invention. Therefore, it should be understood that various equivalents and modifications may be substituted for them at the time of filing the present application.

The present invention includes: generating a laser control signal based on a LiDAR set value; measuring a target spatial resolution for ranging with respect to an object existing at a target maximum distance in a LiDAR scanning laser ranging view through the generated laser control signal; determining a coarse angular resolution to generate a coarse spatial resolution greater than the target spatial resolution at the target maximum distance; obtaining a plurality of coarse ranging values through a first dimensional coarse angular resolution and a second dimensional coarse angular resolution based on the determined coarse angular resolution; determining a first dimensional angular bin size based on the first dimensional coarse angular resolution and the second dimensional coarse angular resolution based on the determined coarse angular resolution; determining a second dimensional minimum angle and a second dimensional maximum angle through the determined first dimensional angle bin size; and performing final ranging through adaptive scanning properties including a set of the obtained coarse ranging values, the second dimension minimum angle, and the second dimension maximum angle.

In addition, the present invention includes: a laser generation unit configured to generate a laser control signal based on a LiDAR set value; a spatial resolution measurement unit configured to measure a target spatial resolution for ranging with respect to an object existing at a target maximum distance in a LiDAR scanning laser ranging view through the generated laser control signal; a coarse angular resolution determination unit configured to determine a coarse angular resolution to generate a coarse spatial resolution greater than the target spatial resolution at the target maximum distance; a coarse ranging unit configured to obtain a plurality of coarse ranging values through a first dimensional coarse angular resolution and a second dimensional coarse angular resolution based on the determined coarse angular resolution; a bin size determination unit configured to determine a first dimensional angular bin size based on the first dimensional coarse angular resolution and the second dimensional coarse angular resolution based on the determined coarse angular resolution; a second dimensional angular determination unit configured to determine a second dimensional minimum angle and a second dimensional maximum angle through the determined first dimensional angle bin size; and an adaptive scanning unit configured to perform final ranging through adaptive scanning properties including a set of the obtained coarse ranging values, the second dimension minimum angle, and the second dimension maximum angle.

In the LiDAR adaptive scanning system and method using image information convergence according to the present invention, a denser scale range resolution can be provided with a small beam size and the light distance detection can perform LiDAR adaptive scanning through image information convergence, which is capable of deriving light ranging through LiDAR without restrictions on space and obstacles through adaptive scanning by converging multiple pieces of information according to images on the basis of direct ranging based on the round trip time of an optical pulse with respect to an object, chirped detection based on the frequency difference between a transmitted chirped optical signal and a return signal scattered from an object, and a sequence of single frequency phase shift distinguishable from natural signals.

In addition, the present invention may be implemented in the form of program instructions that can be executed through various electronic information processing means and recorded in storage media. The storage media may include program instructions, data files, data structures, and the like alone or in combination. The program instructions recorded in the storage media may be specially designed and configured for the present invention, or may be known and available to those skilled in the software field. Examples of the storage media include hardware devices specially configured to store and execute program instructions, including magnetic media such as hard disk, floppy disk, and magnetic tape, optical media such as CD-ROM and DVD, magneto-optical media such as floptical disk, ROM, RAM, and flash memory. In addition, the above-mentioned media may be transmission media such as metal wires, waveguides, or light including a carrier for transmitting signals designating program instructions, data structures, and the like. Examples of the program instructions include not only machine code such as code generated by a compiler, but also a device for electronically processing information using an interpreter or the like, for example, a high-level language code that can be executed by a computer. The above-mentioned hardware devices may be configured to operate as one or more software modules for performing the operations of the present invention, and vice versa.

The present invention has been described focusing on a specific shape and direction with reference to the accompanying drawings, but various modifications and changes can be made thereto by those skilled in the art. Such modifications and changes should be construed as falling within the scope of the present invention.

What is claimed is:

1. A light detection and ranging (LiDAR) adaptive scanning method using image information convergence, the LiDAR adaptive scanning method comprising:
generating a laser control signal based on a LiDAR set value;
measuring a target spatial resolution for ranging with respect to an object existing at a target maximum distance in a LiDAR scanning laser ranging view through the generated laser control signal;
determining a coarse angular resolution to generate a coarse spatial resolution greater than the target spatial resolution at the target maximum distance;
obtaining a plurality of coarse ranging values through a first dimensional coarse angular resolution and a second dimensional coarse angular resolution based on the determined coarse angular resolution;
determining a first dimensional angular bin size based on the first dimensional coarse angular resolution and the second dimensional coarse angular resolution based on the determined coarse angular resolution;
determining a second dimensional minimum angle and a second dimensional maximum angle through the determined first dimensional angle bin size; and
performing final ranging through adaptive scanning properties including a set of the obtained coarse ranging values, the second dimension minimum angle, and the second dimension maximum angle.

2. A light detection and ranging (LiDAR) adaptive scanning system using image information convergence, the LiDAR adaptive scanning system comprising:
a laser generation unit configured to generate a laser control signal based on a LiDAR set value;
a spatial resolution measurement unit configured to measure a target spatial resolution for ranging with respect to an object existing at a target maximum distance in a LiDAR scanning laser ranging view through the generated laser control signal;
a coarse angular resolution determination unit configured to determine a coarse angular resolution to generate a coarse spatial resolution greater than the target spatial resolution at the target maximum distance;
a coarse ranging unit configured to obtain a plurality of coarse ranging values through a first dimensional coarse angular resolution and a second dimensional coarse angular resolution based on the determined coarse angular resolution;
a bin size determination unit configured to determine a first dimensional angular bin size based on the first dimensional coarse angular resolution and the second dimensional coarse angular resolution based on the determined coarse angular resolution;
a second dimensional angular determination unit configured to determine a second dimensional minimum angle and a second dimensional maximum angle through the determined first dimensional angle bin size; and
an adaptive scanning unit configured to perform final ranging through adaptive scanning properties including a set of the obtained coarse ranging values, the second dimension minimum angle, and the second dimension maximum angle.
